(19) United States
(12) Patent Application Publication
(10) Pub. No.: US 2013/0329149 A1
(43) Pub. Date: Dec. 12, 2013

(54) LIQUID CRYSTAL COMPOSITION, METHOD OF FORMING AN OPTICALLY ISOTROPIC PHASE OF A LIQUID CRYSTAL, AND LIQUID CRYSTAL DISPLAY DEVICE INCLUDING THE SAME

(71) Applicants: Industrial Cooperation Foundation Chonbuk National University, (US); SAMSUNG DISPLAY CO., LTD., Yongin-City (KR)

(72) Inventors: Jae-Soo JANG, Suwon-si (KR); Shin-Woong KANG, Jeonju-si (KR); Su-Yeon OH, Jeonju-si (KR); Seung-Hee LEE, Jeonju-si (KR); Se-Hyun LEE, Seoul (KR); Hyeok-Jin LEE, Seongnam-si (KR); Seung-Ho HONG, Gunpo-si (KR)

(73) Assignees: Industrial Cooperation Foundation Chonbuk National University, Jeonju-si (KR); SAMSUNG DISPLAY CO., LTD., Yongin-City (KR)

(21) Appl. No.: 13/764,268

(22) Filed: Feb. 11, 2013

(30) Foreign Application Priority Data
Jun. 7, 2012 (KR) 10-2012-0060981

(51) Int. Cl. C09K 19/56; G02F 1/133

(52) U.S. Cl. CPC C09K 19/56; G02F 1/13306
USPC 349/41; 252/299.01

(57) ABSTRACT

A liquid crystal composition including about 70 percent by weight to about 98 percent by weight of a liquid crystal molecule; and about 2 percent by weight to about 30 percent by weight of a hydrogel agent, each based on a total weight of the liquid crystal composition.

This application claims priority to Korean Patent Application No. 10-2012-0060981, filed on Jun. 7, 2012, and all the benefits accruing therefrom under 35 U.S.C. §119, the content of which in its entirety is incorporated herein by reference.

### BACKGROUND

1. Technical Field

An embodiment of the present disclosure relates to a liquid crystal composition, a method of forming an optically isotropic phase of the liquid crystal, and a liquid crystal display device. More particularly, an embodiment of the present disclosure relates to a liquid crystal composition that may be used in a liquid crystal display device, a method of forming an optically isotropic phase of the liquid crystal, and a liquid crystal display device.

2. Description of the Related Art

A liquid crystal display device is widely being used as a display device since the liquid crystal display device has advantages such as light weight and a small thickness, when compared to a CRT display device. The liquid crystal display device includes an array substrate including a pixel array, an opposing substrate combined with the array substrate and a liquid crystal layer interposed between the array substrate and the opposing substrate. The liquid crystal display device controls an orientation of liquid crystal molecules in the liquid crystal layer to change a light transmittance, thereby displaying an image.

Examples of a liquid crystal that may be used for the liquid crystal display device may include a nematic liquid crystal, a smectic liquid crystal, a cholesteric liquid crystal, and the like. The nematic liquid crystal is generally used since the nematic liquid crystal has relatively better reliability. However, a liquid crystal display device using the nematic crystal is often used with an alignment film to pre-tilt the liquid crystal molecules, and has a small viewing angle. Furthermore, the liquid crystal display device using the nematic liquid crystal has a lower response speed so that it is difficult to achieve a high resolution and a high frequency driving with the nematic liquid crystal.

In order to solve the above-mentioned disadvantages, a liquid crystal display device using an optically isotropic liquid crystal is being researched and developed. The optically isotropic liquid crystal macroscopically has an optically isotropic phase. Thus, the optically isotropic liquid crystal does not have to include an alignment film to pre-tilt liquid crystal molecules, and has a high response speed.

In order to form the optically isotropic liquid crystal, a blue phase liquid crystal can be formed. However, the blue phase liquid crystal is formed from the smectic liquid crystal or the cholesteric liquid crystal, which has a relatively low stability, so that it is difficult to increase a driving reliability of a liquid crystal display device. Thus there remains a need for an improved liquid crystal composition.

### SUMMARY

An embodiment provides a liquid crystal composition capable of forming an optically isotropic liquid crystal having an improved stability.

An embodiment further provides a method of forming an optically phase of liquid crystal using the liquid crystal composition

An embodiment further provides a liquid crystal display device including the liquid crystal composition.

According to an embodiment, a liquid crystal composition includes about 70% by weight to about 98% by weight of a liquid crystal molecule, and about 2% by weight to about 30% by weight of a hydro gel agent.

In an embodiment, the liquid crystal molecule includes at least one selected from a nematic liquid crystal, a smectic liquid crystal, and a cholesteric liquid crystal.

In an embodiment, the hydrogel agent includes an alkylamide compound, and the alkylamide compound includes at least one selected from the compounds represented by the following Chemical Formulas 21 and 22.

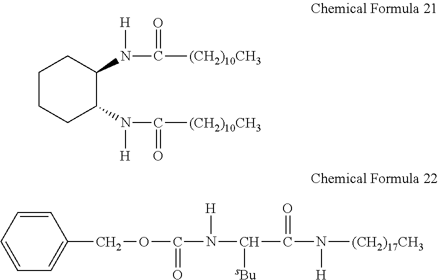

In Chemical Formula 22, “^{S}Bu” refers to a secondary butyl group.

In an embodiment, the hydrogel agent includes a hydroxyalkylamide compound, and the hydroxyalkylamide compound includes at least one compound selected from compounds represented by the following Chemical Formulas 23, 24, 25, 26 and 27.

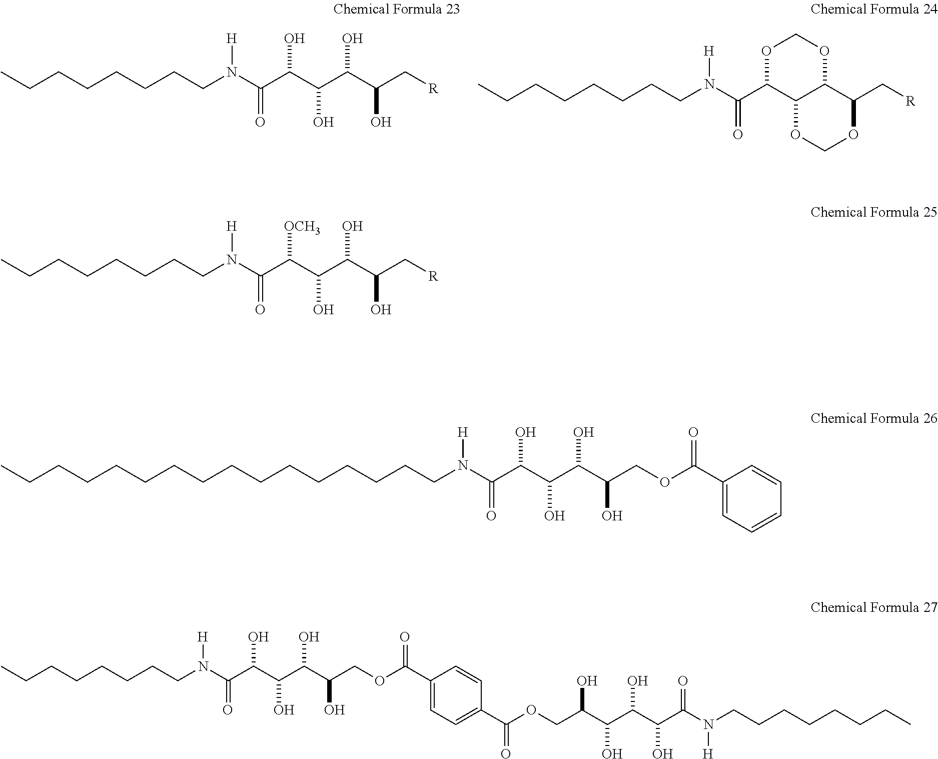

In Chemical Formula 23, R represents at least one selected from —OH,

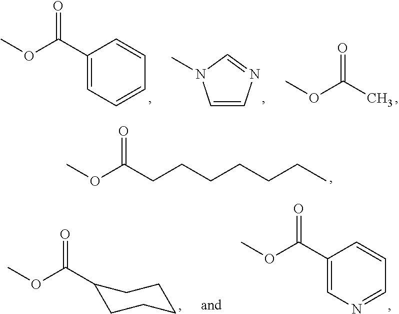

in Chemical Formula 24, R represents at least one selected from —OH,

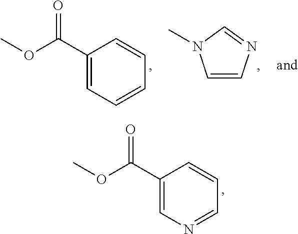

and in Chemical Formula 25, R represents at least one selected from —OH,

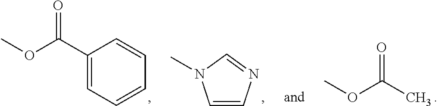

In an embodiment, the liquid crystal composition further includes a chiral dopant in an amount of greater than about 20% by weight.

According to an embodiment, a method of forming an optically isotropic phase of a liquid crystal includes heating a liquid crystal composition including about 70% by weight to about 98% by weight of a liquid crystal molecule, and about 2% by weight to about 30% by weight of a hydrogel agent, each based on a total weight of the liquid crystal composition; and cooling the liquid crystal composition.

In an embodiment, the liquid crystal composition is heated such that a temperature of the liquid crystal composition is equal to or greater than a phase transition temperature of the liquid crystal composition. For example, the temperature of the heated liquid crystal composition is about 80° C. to 130° C.

According to an embodiment, a liquid crystal display device includes an array substrate including a switching element and a pixel electrode electrically connected to the switching element, an opposing substrate facing the array substrate and a liquid crystal layer including a liquid crystal composition including about 70% by weight to about 98% by weight of a liquid crystal molecule, and about 2% by weight to about 30% by weight of a hydrogel agent, each based on a total weight of the liquid crystal composition.

In an embodiment, the array substrate further includes a common electrode provided with a voltage to form an electric field with pixel electrode.

In an embodiment, the liquid crystal composition has an optically isotropic phase when an electric field is not formed between the pixel electrode and the common electrode.

According to the above, a liquid crystal composition includes a hydrogel agent thereby forming a gel network including a plurality of domains randomly arranged in the liquid crystal composition. Thus, the liquid crystal composition may form an optically phase of liquid crystal, and may achieve a liquid crystal display device not including an orientation film.

### BRIEF DESCRIPTION OF THE DRAWINGS

An embodiment can be understood in more detail from the following detailed description when taken in conjunction with the accompanying drawings, in which:

FIG. 1 is a cross-sectional view illustrating an embodiment of a liquid crystal display device;

FIG. 2 is an enlarged plan view illustrating an embodiment of a pixel unit of the liquid crystal display panel illustrated in FIG. 1;

FIG. 3 is a cross-sectional view taken along line I-I′ of FIG. 2; and

FIGS. 4 and 5 are cross-sectional views illustrating an embodiment of liquid crystal driving of an embodiment of a liquid crystal display device.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

“Alkylamide” as used herein means a group of the formula —C(O)—N(Rx)(Ry) or —N—C(O)—Rx, wherein Rx and Ry are each independently H or a substituted or unsubstituted C1-C30 alkyl group.

“Hydroxyalkylamide” as used herein means an alkylamide containing at least one hydroxyl group.

“Alkyl” as used herein means “Alkyl” means a straight or branched chain, saturated, monovalent hydrocarbon group (e.g., methyl or hexyl).

“Substituted” means that the compound or group is substituted with at least one (e.g., 1, 2, 3, or 4) substituent independently selected from a hydroxyl (—OH), a nitro (—NO₂), a cyano (—CN), an amino (—NH₂), an azido (—N₃), an amidino (—C(═NH)NH₂), a hydrazino (—NHNH₂), a hydrazono (—C(═NNH₂)—), a carbonyl (—C(═O)—), a carbamoyl group (—C(O)NH₂), a sulfonyl (—S(═O)₂—), a thiol (—SH), a thiocyano (—SCN), a tosyl (CH₃C₆H₄SO₂—), a carboxylic acid (—C(═O)OH), a carboxylic C1 to C6 alkyl ester (—C(═O)OR wherein R is a C1 to C6 alkyl group), a carboxylic acid salt (—C(═O)OM) wherein M is an organic or inorganic anion, a sulfonic acid (—SO₃H₂), a sulfonic mono- or dibasic salt (—SO₃MH or —SO₃M₂ wherein M is an organic or inorganic anion), a phosphoric acid (—PO₃H₂), a phosphoric acid mono- or dibasic salt (—PO₃MH or —PO₃M₂ wherein M is an organic or inorganic anion), a C1 to C12 alkyl, a C3 to C12 cycloalkyl, a C2 to C12 alkenyl, a C5 to C12 cycloalkenyl, a C2 to C12 alkynyl, a C6 to C12 aryl, a C7 to C13 arylalkylene, a C4 to C12 heterocycloalkyl, a C3 to C12 heteroaryl instead of hydrogen, a

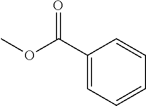

group, a

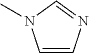

group, a

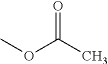

group, a

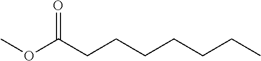

group, a

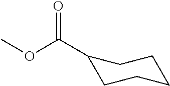

group, and a

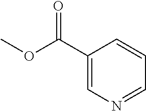

group, provided that the substituted atom's normal valence is not exceeded.

Hereinafter, a liquid crystal composition and a method of forming an optically isotropic phase of liquid crystal according to an embodiment will be explained in further detail. Thereafter, a liquid crystal display device including the liquid crystal composition according to an embodiment will be explained.

### Liquid Crystal Composition

A liquid crystal composition according to an embodiment includes a liquid crystal molecule in an amount of about 70 percent (%) by weight to about 98% by weight; and a hydrogel agent in an amount of about 2% by weight to about 30% by weight, each based on a total weight of the liquid crystal composition.

For example, the liquid crystal molecule may include at least one selected from a nematic liquid crystal, a smectic liquid crystal, and a cholesteric liquid crystal, and the like. An available liquid crystal molecule may be used as the liquid crystal molecule. Particularly, examples of the liquid crystal molecule may include compounds represented by the following Chemical Formulas 1 to 20.

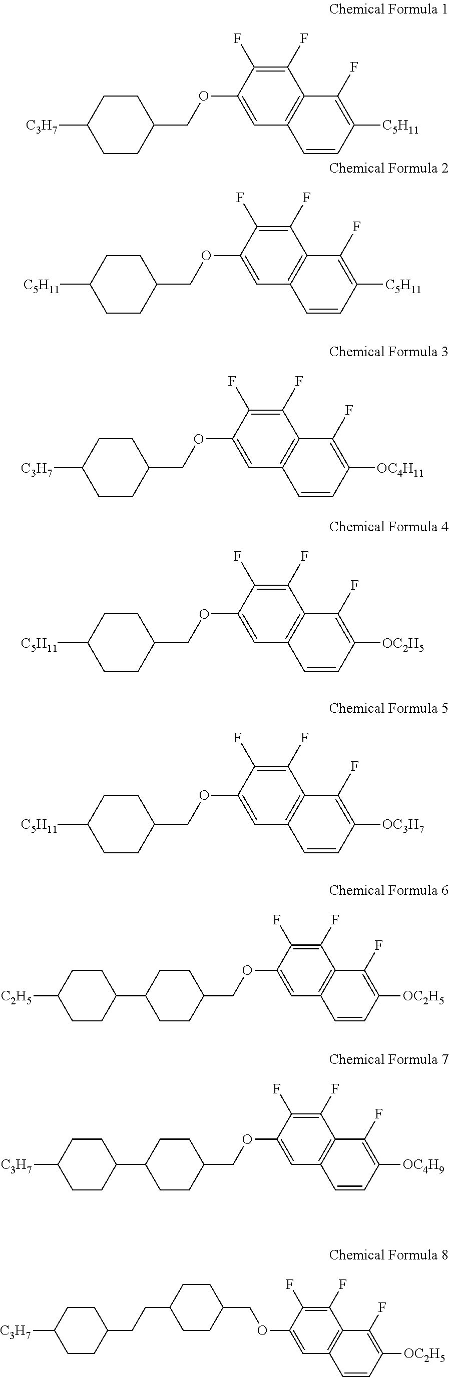

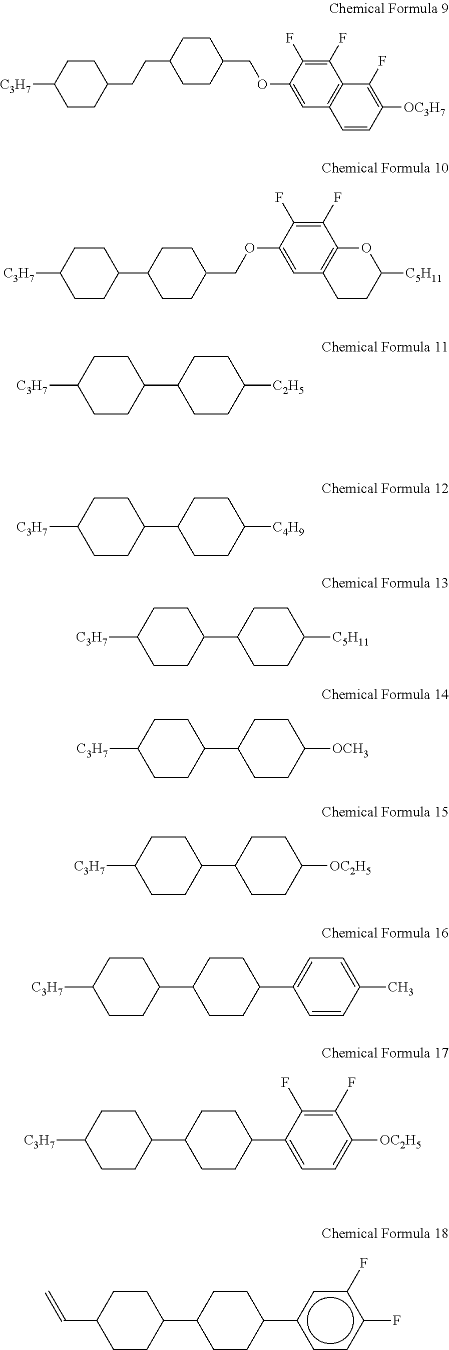

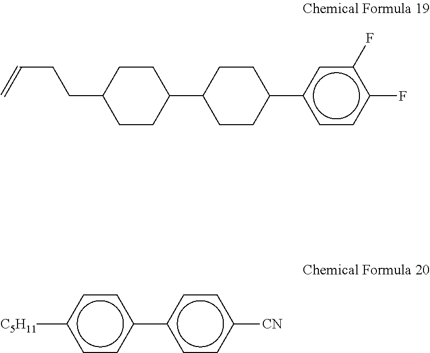

Preferably, the liquid crystal has a nematic phase. The liquid crystal composition is capable of forming an optically isotropic phase and may comprise a nematic liquid crystal, which has a relatively high stability and rarely forms a blue phase. Thus, a stability of an optically isotropic liquid crystal may be improved.

When the amount of the liquid crystal is less than about 70% by weight, based on a total weight of the liquid crystal composition, an induced birefringence may be reduced, and a driving voltage may be increased. When the amount of the liquid crystal is greater than about 98% by weight, a response speed may be reduced. Thus, the amount of the liquid crystal may be about 70% by weight to about 98% by weight, based on a total weight of the liquid crystal composition, specifically about 80% by weight to about 98% by weight, more specifically about 90% by weight to about 98% by weight, even more specifically about 95% by weight to about 98% by weight.

The hydrogel agent forms a hydrogen bond in the liquid crystal composition. For example, the hydrogel agent may form a gel network in the liquid crystal composition. The liquid crystal molecules may be dispersed in the gel network, and may form a plurality of domains having a size smaller than a wavelength of visible light, for example, about 10 nanometers (“nm”) to several hundred nanometers, specifically 10 nm to 800 nm. The domains may be randomly arranged.

The liquid crystal molecules are orientated in a direction to have anisotropy in each of the domains. However, the domains may be oriented in different directions from each other. When the size of the domains is smaller than a wavelength of visible light, the liquid crystal composition may entirely have an optically isotropic phase due to a spatial average effect when an electric field is not applied thereto. When an electric field is applied to the liquid crystal composition, the liquid crystal composition may be optically anisotropic, and may be effective for use as an optical shutter for a display panel.

For example, the hydrogel agent may include an alkylamide compound. The molecular weight of the alkylamide compound may be about 200 to about 3,000 Daltons (Da), specifically about 500 to about 3,000 (Da).

Particularly, examples of the hydrogel agent may include an alkylamide compound represented by the following Chemical Formulas 21 and 22.

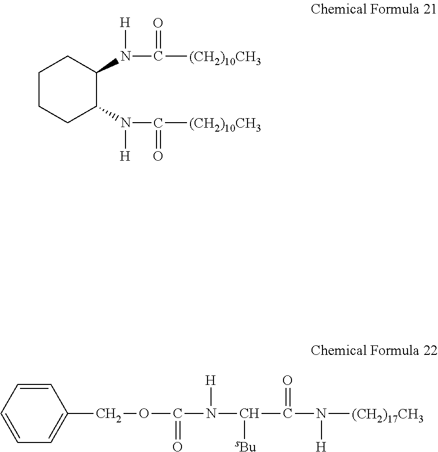

In Chemical Formula 22, “^{S}Bu” refers to a secondary butyl group.

Furthermore, examples of the hydrogel agent may include a hydroxyalkylamide compound represented by the following Chemical Formulas 23 to 27.

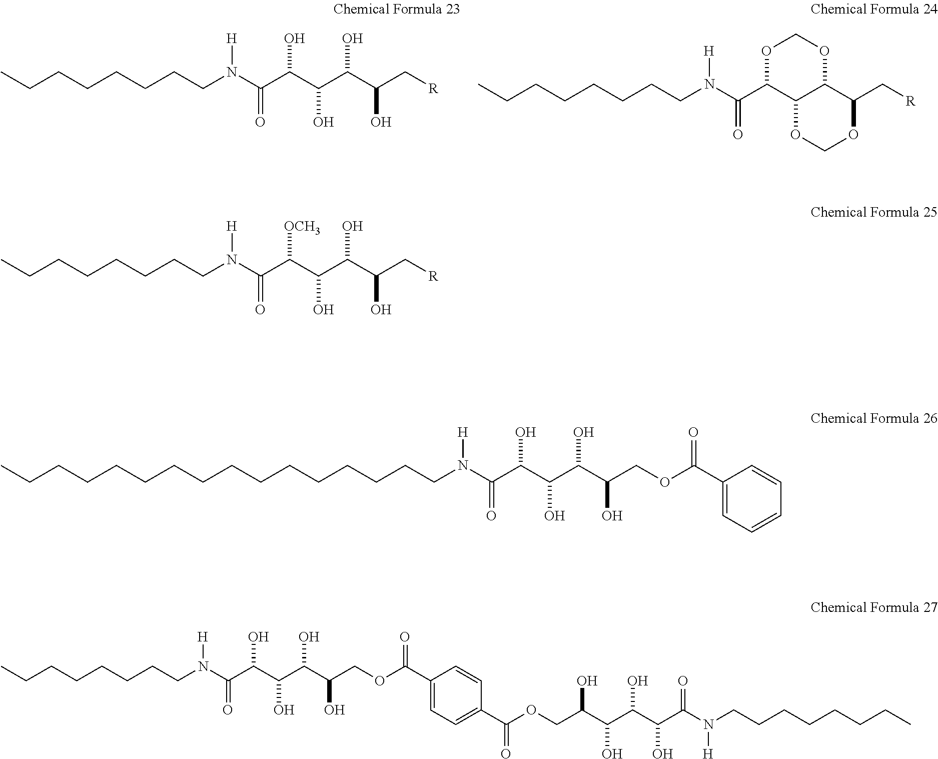

In Chemical Formula 23, R represents at least one selected from —OH,

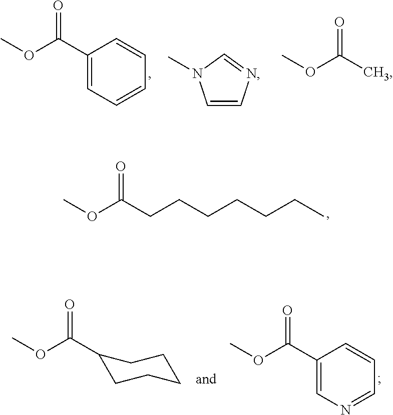

in
Chemical Formula 24, R represents at least one selected from —OH,

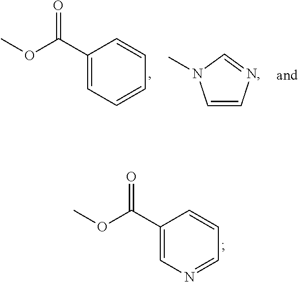

and in Chemical Formula 25, R represents at least one
selected from —OH,

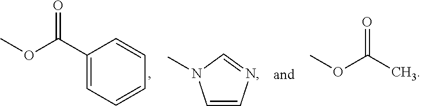

The liquid crystal composition may further include a chiral dopant. The chiral dopant may reduce the size of the domains to substantially or effectively prevent light passing through the optically isotropic liquid crystal from scattering.

Examples of the chiral agent may include at least one compound selected from the compounds represented by the following Chemical Formulas 28 to 30.

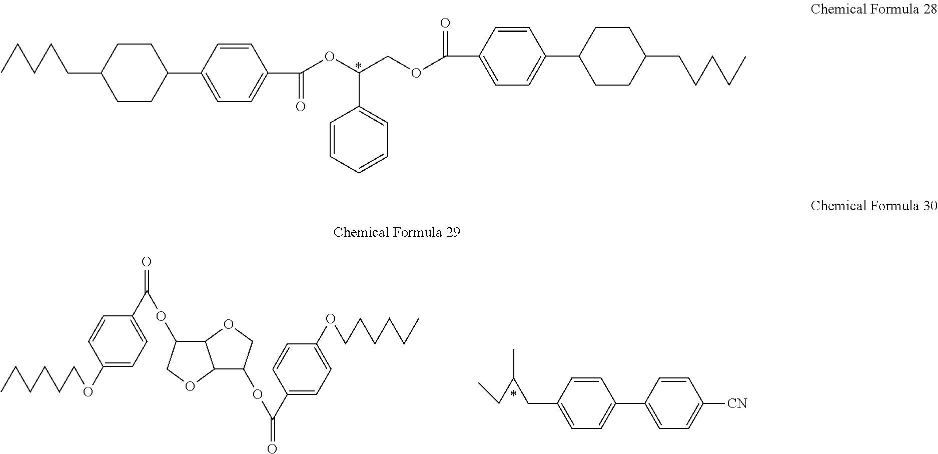

In Chemical Formula 28, the symbol “*” represents a chiral center. Accordingly, a compound represented by Chemical Formula 28 may be a pure (R)-enantiomer, a pure (S)-enantiomer, or a mixture of the (R)-enantiomer and the (S)-enantiomer.

When the amount of the chiral dopant is excessive, a driving voltage may be increased. Thus, the amount of the chiral dopant may be selected to be no greater than about 20% by weight, based on a total weight of the liquid crystal composition, specifically no greater than about 15% by weight, based on a total weight of the liquid crystal composition, more specifically no greater than about 10% by weight, based on a total weight of the liquid crystal composition, specifically about 1% by weight to about 20% by weight, based on a total weight of the liquid crystal composition.

According to the above, the liquid crystal composition includes the hydrogel agent and forms a gel network forming a plurality of domains randomly arranged in the liquid crystal composition. Thus, the liquid crystal composition may form an optically isotropic phase of the liquid crystal.

### Method of Forming Optically Isotropic Phase of a Liquid Crystal

In a method of forming an optically isotropic phase of liquid crystal according to an embodiment, a liquid crystal composition is prepared. The liquid crystal composition includes about 70% by weight to about 98% by weight of a liquid crystal molecule, and about 2% by weight to about 30% by weight of a hydrogel agent. The liquid crystal composition may further include less than about 20% by weight of a chiral dopant.

Additional details of the liquid crystal composition are provided above, and thus, any duplicated explanation will be omitted for clarity.

Thereafter, the liquid crystal composition is heated at a temperature of equal to or greater than a phase transition temperature of the liquid crystal composition so that the liquid crystal composition attains a temperature of equal to or greater than the phase transition temperature. For example, the liquid crystal composition may be heated at about 80° C. to about 130° C. When the liquid crystal composition is heated at a temperature equal to or greater than the phase transition temperature, a hydrogen bond formed by the hydrogel agent may be destroyed and the liquid crystal molecule may form an optically isotropic phase. Thus, the liquid crystal composition forms an optically isotropic mixture. When the liquid crystal composition is heated at a temperature less than the phase transition temperature, it can be difficult to form a uniform optical isotropic phase. When the liquid crystal composition is heated at a high temperature, e.g., a temperature higher than the phase transition temperature, the liquid crystal composition may be deteriorated or decomposed.

Thereafter, the heated liquid crystal composition is cooled. As the temperature of the liquid crystal composition is reduced, the hydrogel agent forms a gel network in the liquid crystal composition. The liquid crystal molecules may be dispersed in the gel network, and may form a plurality of domains preferably having a size smaller than a wavelength of visible light, for example, about 10 nm to several hundred nanometers.

The liquid crystal molecules are oriented in a direction to have anisotropy in each of the domains. However, the domains are entirely randomly arranged and are oriented in different directions from each other, thereby forming an optically isotropic phase of a liquid crystal.

According to the above, after heating at a temperature equal to or greater than the phase transition temperature, the liquid crystal composition including the hydrogel agent is cooled so that an optically isotropic phase of liquid crystal may be uniformly formed.

### Liquid Crystal Display Device

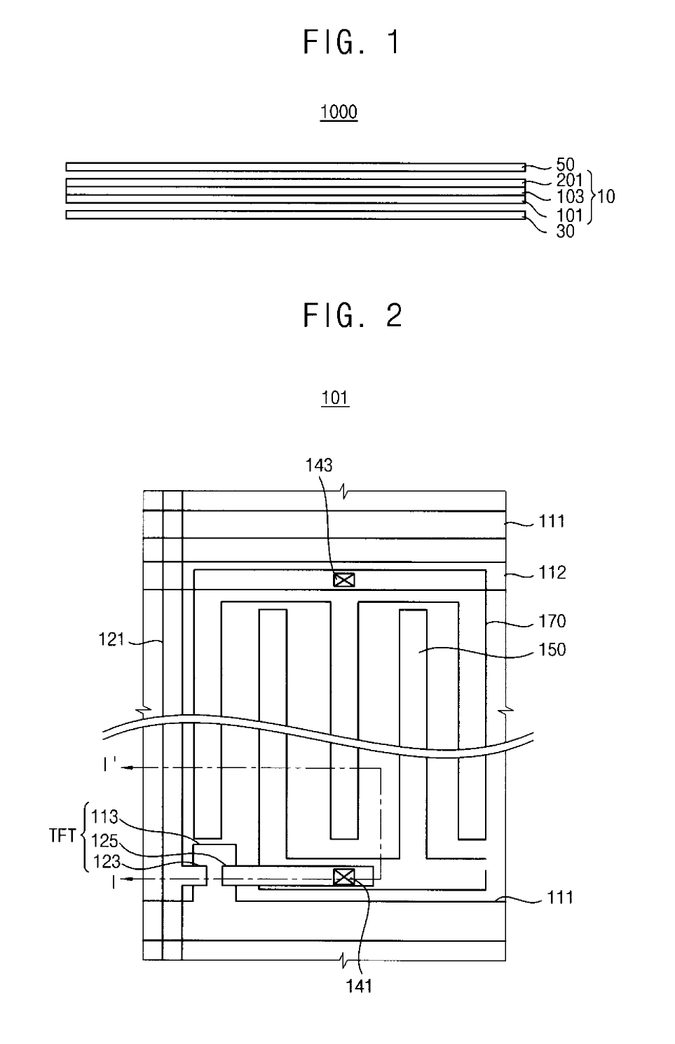

FIG. 1 is a cross-sectional view illustrating a liquid crystal display device according to an embodiment.

Referring to FIG. 1, a liquid crystal display device 1000 includes a liquid crystal display panel 10, a first polarizing member 30 and a second polarizing member 50. The liquid crystal display device 1000 further includes a backlight assembly (not shown) for providing a light to the liquid crystal display panel 10. The backlight assembly is disposed under the second polarizing member 50.

The first and second polarizing members 30 and 50 may be spaced apart from the liquid crystal display panel 10. Alternatively, the first and second polarizing members 30 and 50 may be combined with the liquid crystal display panel 10, or may be formed in the liquid crystal display panel 10.

The liquid crystal display panel 10 includes an array substrate 101, an opposing substrate 201 facing the array substrate 101, and a liquid crystal layer 103 interposed between the array substrate 101 and the opposing substrate 201.

The first polarizing member 30 is disposed to face a lower surface of the array substrate 101, and converts an incident light provided from the backlight assembly into a first polarized light. The second polarizing member 50 is disposed to face a display surface, which is an upper surface of the opposing substrate 201. A polarizing axis of the first polarizing member 30 is substantially perpendicular to a polarizing axis of the second polarizing member 50. Directions of the polarizing axes of the first and second polarizing members 30 and 50 may vary depending on a direction of an electric field formed in the liquid crystal display panel 10. For example, the polarizing axes of the first and second polarizing members 30 and 50 may respectively form an angle of about 45° with respect to a horizontal direction of the electric field.

While the first polarized light passes through the liquid crystal layer 103, the first polarized light may be phase-delayed or not depending on an orientation of liquid crystal molecules. In the present embodiment, the second polarizing member 50 transmits the phase-delayed first polarized light and blocks the first polarized light that is not phase-delayed.

FIG. 2 is an enlarged plan view illustrating a pixel unit of the liquid crystal display panel illustrated in FIG. 1. FIG. 3 is a cross-sectional view taken along line I-I′ of FIG. 2.

Referring to FIGS. 2 and 3, the array substrate 101 includes a lower substrate 110, a signal line, a gate insulation layer 117, a switching element TFT, a passivation layer 140, a pixel electrode 150, a common electrode 170 and a protective layer 160. The signal line may include a gate line 111, a common electrode line 112 and a data line 121.

A gate line 111 extending in a first direction, a gate electrode 113 and a common electrode line 112 are formed on the lower substrate 110 including glass, plastic or the like. The gate insulation layer 117 includes an inorganic material such as silicon nitride, silicon oxide or the like, and covers the gate line 111, the gate electrode 113 and the common electrode line 112. A channel layer 118 is formed on the gate insulation layer 117 to overlap with the gate electrode 113. The channel layer 118 may include amorphous silicon. An ohmic contact layer 119 is formed on the channel layer 118. The ohmic contact layer 119 may include amorphous silicon doped with impurities at a high concentration.

A data line 121 extending in a second direction crossing the first direction, a source electrode 123 extending from the data line 121, and a drain electrode 125 spaced apart from the source electrode 123 are formed on the gate insulation layer 117.

The gate electrode 113, the gate insulation layer 117, the channel layer 118, the ohmic contact layer 119, the source electrode 123 and the drain electrode 125 constitute the switching element TFT. When a gate voltage is applied to the gate electrode 113 through the gate line 111, a data voltage that is applied to the source electrode 123 through the data line 121, is applied to the drain electrode 125 through the channel layer 118.

The passivation layer 140 covers the switching element TFT. The passivation layer 140 may include an inorganic material such as silicon oxide, silicon nitride or the like, or an organic material.

The pixel electrode 150 and the common electrode 170 are disposed on the passivation layer 140, and include a transparent conductive material such as indium tin oxide (“ITO”), indium zinc oxide (“IZO”), or the like. The pixel electrode 150 and the common electrode 170 are electrically connected respectively to the drain electrode 125 and the common electrode line 112 through contact holes 141 and 143 formed through the passivation layer 140.

The pixel electrode 150 includes a plurality of branches extending in a direction. The common electrode 170 includes a plurality of branches extending in a direction and disposed respectively between adjacent branches of the pixel electrode 150. For example, the branches of the pixel electrode 150 and the common electrode 170 extend in the second direction.

When a voltage is applied to the pixel electrode 150 and the common electrode 170, a horizontal electric field is formed between the branches of the pixel electrode 150 and the branches of the common electrode 170.

In the present embodiment, the pixel electrode 150 and the common electrode 170 are formed on a same substrate to form a horizontal electric field. Alternatively, a pixel electrode and a common electrode may be formed on different substrates to form a vertical electric field.

The opposing substrate 201 includes an upper substrate 210, a light-blocking layer 220, a color filter 230 and an over-coating layer 240.

The upper substrate 210 faces the lower substrate 110, and includes the same material as the lower substrate 110, for example, glass, plastic, or the like. The light-blocking layer 220 is formed on the upper substrate 210 to overlap with the switching element TFT, the gate line GL, the common electrode line 112 and the data line 121. The light-blocking layer 220 may include an organic material or a metallic material including chromium.

The color filter 230 is formed on the upper substrate 210 having the light-blocking layer 220. For example, the color filter 230 may include a red color filter, a green color filter and a blue color filter. The color filter 230 may partially cover the light-blocking layer 220.

The overcoating layer 240 is formed on the color filter 230 and the light-blocking layer 220 to planarize the upper substrate 210.

In the present embodiment, the color filter 230 is formed on the upper substrate 210 having the light-blocking layer 220. Alternatively, a color filter may be formed on the array substrate 101 having the pixel electrode 150.

The liquid crystal layer 102 includes a liquid crystal composition. The liquid crystal composition includes about 70% by weight to about 98% by weight of a liquid crystal molecule, and about 2% by weight to about 30% by weight of a hydrogel agent, each based on a total weight of the liquid crystal composition. The liquid crystal composition may further include no more than about 20% by weight of a chiral dopant, based on a total weight of the liquid crystal composition.

Additional details of the liquid crystal composition are provided above, and thus, any duplicated explanation will be omitted herein.

The hydrogel agent forms a gel network in the liquid crystal composition. The liquid crystal molecules may be dispersed in the gel network, and may form a plurality of domains preferably having a size smaller than a wavelength of a visible ray, for example, about 10 nm to several hundred nanometers, specifically about 10 nm to about 800 nm.

The liquid crystal molecules are oriented in a direction to have anisotropy in each of the domains. However, the domains are entirely randomly arranged and are oriented in different directions from each other, thereby forming an optically isotropic phase of the liquid crystal.

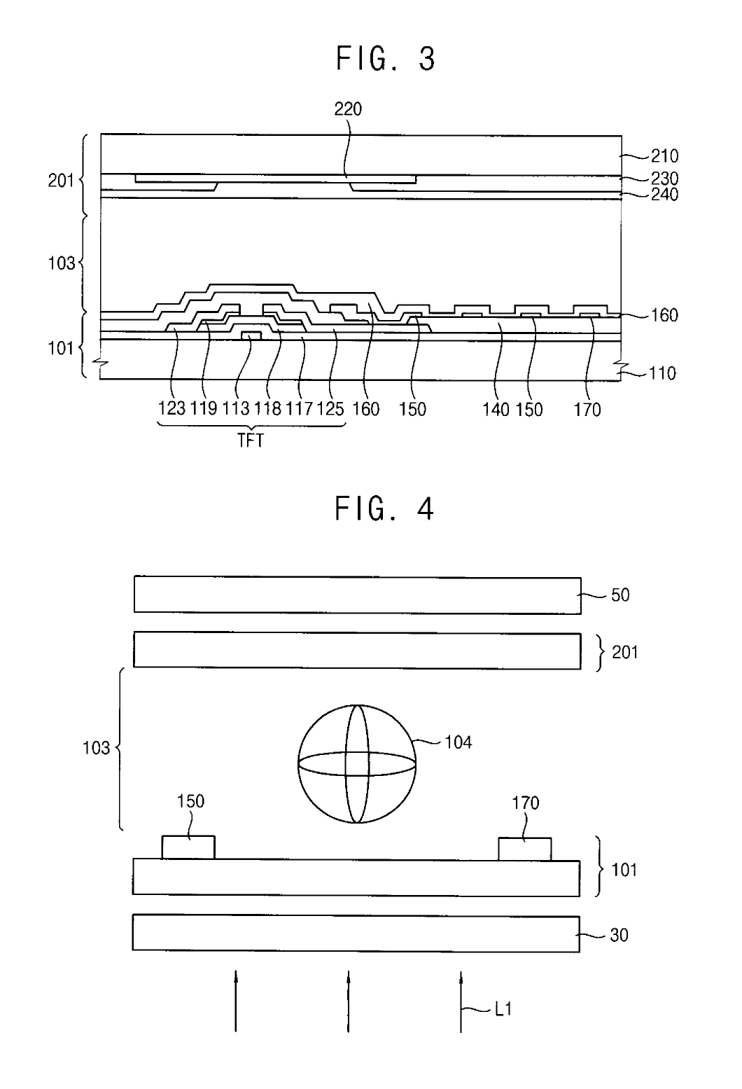

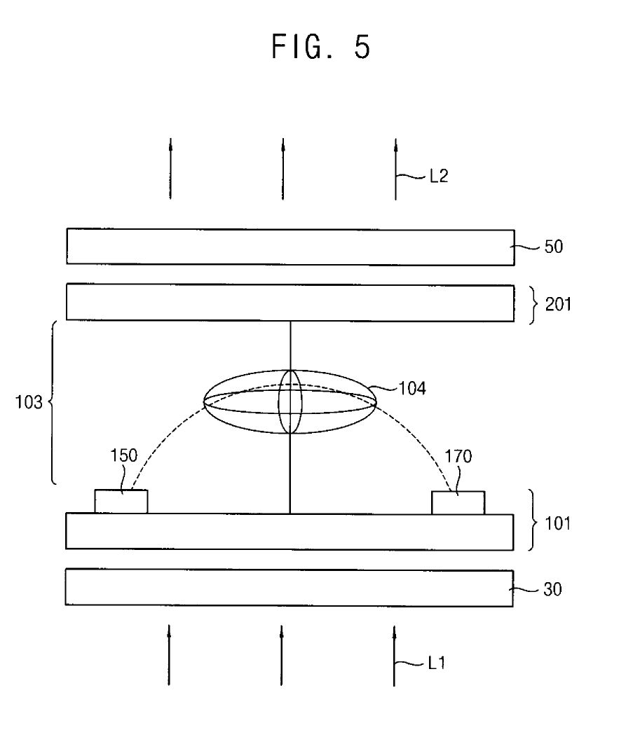

FIGS. 4 and 5 are cross-sectional views illustrating liquid crystal driving of a liquid crystal display device according to an embodiment.

Referring to FIG. 4, when an electric field is not applied to the liquid crystal layer 103, the liquid crystal molecules 104 of the liquid crystal layer 103 have an optically isotropic phase. The first polarizing member 30 converts an incident light L1, which is provided from a backlight assembly, to a first polarized light.

The first polarized light is not phase-delayed when the first polarized light passes through the liquid crystal layer 103, and the second polarizing member 50 has a polarizing axis perpendicular to a polarizing axis of the first polarizing member 30. Thus, the first polarized light cannot pass through the second polarizing member 50. Thus, an observer perceives a black image.

Referring to FIG. 5, when an electric field is applied to the liquid crystal layer 103, the liquid crystal molecules 104 of the liquid crystal layer 103 are oriented by the electric field to be optically anisotropic.

Thus, the first polarized light is phase-delayed when the first polarized light passes through the liquid crystal layer 103. Thus, at least a portion of the first polarized light passes through the second polarizing member 50 so that an exiting light L2 is emitted. Thus, an observer perceives a white image.

In the present embodiment, the liquid crystal display panel includes an optically isotropic liquid crystal. Thus, the liquid crystal display panel does not have to include an orientation film to pre-tilt liquid crystal molecules. Thus, manufacturing cost of a liquid crystal display device may be reduced.

Furthermore, the optically isotropic liquid crystal may achieve a uniform extinction not depending on a view angle. Thus, an image quality may be increased.

Hereinafter, effects of an embodiment will be further disclosed with reference to experimental results.

### Experiment 1

After deposited on a glass substrate, an indium tin oxide layer was patterned to prepare a first substrate including a first electrode and a second electrode electrically insulated from the first electrode. The first substrate was combined with a second substrate that was a glass substrate to prepare a cell having a cell gap of about 10 micrometers (“μm”).

A liquid crystal composition including about 87% by weight of a nematic liquid crystal (made by Merck, Germany), about 10% by weight of the hydrogel agent represented by Chemical Formula 21 and about 3% by weight of the chiral dopant represented by Chemical Formula 28 was prepared. After the liquid crystal composition was heated at about 110° C., the liquid crystal composition was injected into the cell, and the liquid crystal composition was cooled at about 1 degree centigrade per minute (° C./min) to a room temperature.

### Experiment 2

A liquid crystal composition including about 87% by weight of the nematic liquid crystal (made by Merck, Germany), about 10% by weight of the hydrogel agent represented by Chemical Formula 22 and about 3% by weight of the chiral dopant represented by Chemical Formula 28 was prepared. After the liquid crystal composition is heated at about 90° C., the liquid crystal composition was injected into a cell substantially same as the cell of Experiment 1, and the liquid crystal composition was cooled at about 1° C./min to a room temperature.

Polarizing members having polarizing axis perpendicular to each other were disposed respectively on and under the cells of Experiments 1 and 2, and the cells were observed with being rotated parallel to a horizontal plane. As a result, it was confirmed the cells did not transmit an incident light. Thus, it can be noted that the liquid crystal composition according to examples may form an optically isotropic phase of the liquid crystal.

Furthermore, voltages were applied to the first and second electrodes of the cells of Experiments 1 and 2 such that a potential difference was about 40 volts (“V”), and the cells were observed while being rotated parallel to a horizontal plane. As a result, brightness of the cells was greatest when the polarizing axis formed about 45° angle with respect to a horizontal direction of an electric field. Thus, it can be noted that the liquid crystal composition having an optically isotropic phase may have an optically anisotropic phase from an electric field thereby functioning as an optical shutter.

Having described an embodiment, it is further noted that it is readily apparent to those of reasonable skill in the art that various modifications may be made without departing from the spirit and scope of the invention which is defined by the metes and bounds of the appended claims.

What is claimed is:

1. A liquid crystal composition comprising:
about 70 percent by weight to about 98 percent by weight of a liquid crystal molecule; and
about 2 percent by weight to about 30 percent by weight of a hydrogel agent, each based on a total weight of the liquid crystal composition.

2. The liquid crystal composition of claim 1, wherein the liquid crystal molecule comprises at least one selected from a nematic liquid crystal, a smectic liquid crystal and a cholesteric liquid crystal.

3. The liquid crystal composition of claim 1, wherein the hydrogel agent comprises an alkylamide compound.

4. The liquid crystal composition of claim 3, wherein the alkylamide compound comprises at least one selected from the compounds represented by Chemical Formulas 21 and 22:

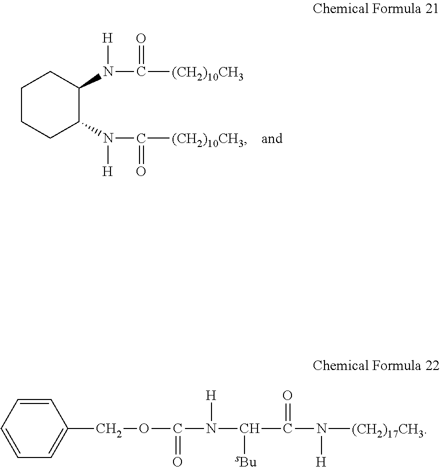

5. The liquid crystal composition of claim 3, wherein the hydrogel agent comprises a hydroxyalkylamide compound.

6. The liquid crystal composition of claim 5, wherein the hydroxyalkylamide compound comprises at least one selected from the compounds represented by Chemical Formulas 23 to 27: 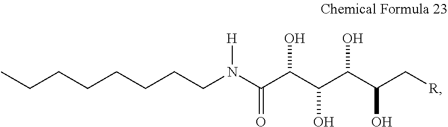
wherein, in Chemical Formula 23, R represents at least one selected from —OH, 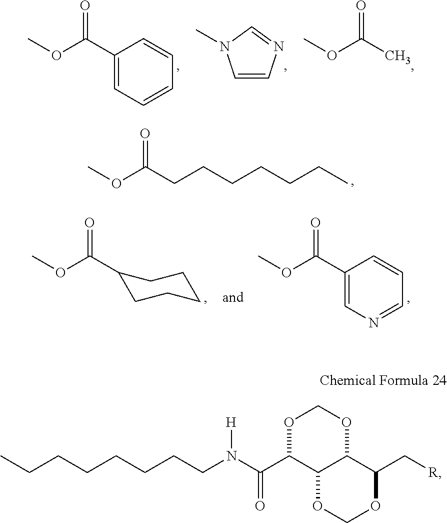
wherein in Chemical Formula 24, R represents at least one selected from —OH, 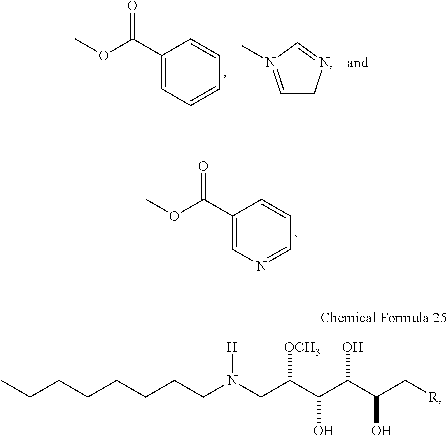
wherein in Chemical Formula 25, R represents at least one selected from —OH,

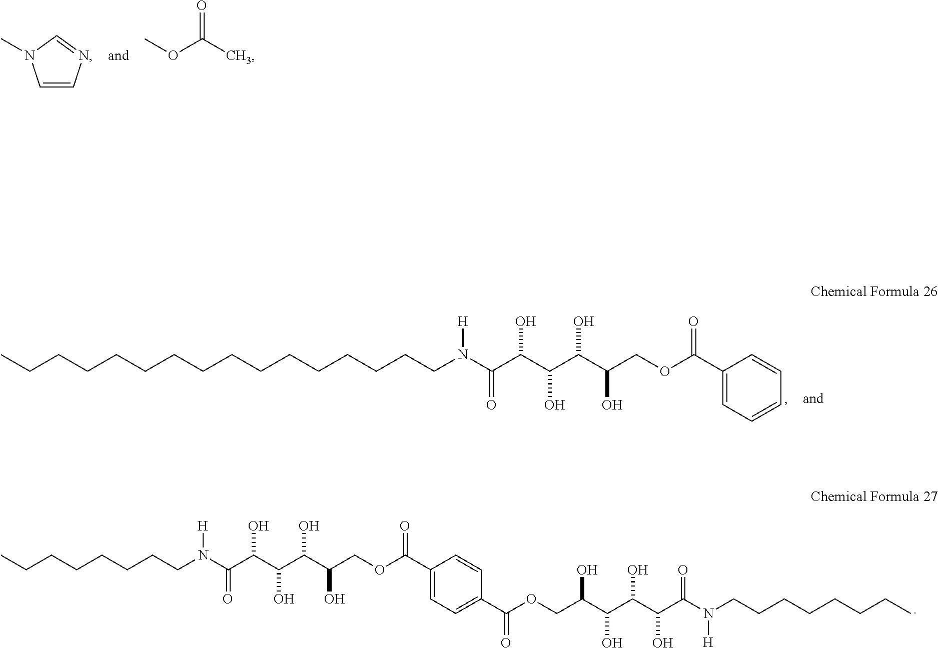

7. The liquid crystal composition of claim 1, further comprising less than about 20 percent by weight of a chiral dopant, based on a total weight of the liquid crystal composition.

8. A method of forming an optically isotropic phase of a liquid crystal, the method comprising:
heating a liquid crystal composition comprising
about 70 percent by weight to about 98 percent by weight of a liquid crystal molecule, and
about 2 percent by weight to about 30 percent by weight of a hydrogel agent, each based on a total weight of the liquid crystal composition; and
cooling the liquid crystal composition to form the optically isotropic phase of the liquid crystal.

9. The method of claim 8, wherein the liquid crystal composition is heated at a temperature of equal to or greater than a phase transition temperature of the liquid crystal composition.

10. The method of claim 9, wherein the temperature of the heated liquid crystal composition is about 80° C. to 130° C.

11. The method of claim 8, wherein the liquid crystal composition further comprises less than about 20 percent by weight of a chiral dopant, based on a total weight of the liquid crystal composition.

12. The method of claim 8, wherein the hydrogel agent comprises an alkylamide compound.

13. The method of claim 12, wherein the alkylamide compound comprises at least one selected from the compounds represented by Chemical Formulas 21 and 22:

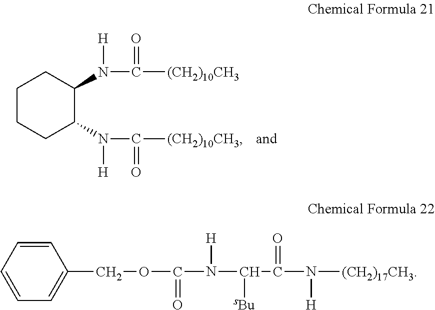

14. The method of claim 12, wherein the hydrogel agent comprises a hydroxyalkylamide compound.

15. The method of claim 14, wherein the hydroxyalkylamide compound comprises at least one selected from the compounds represented by Chemical Formulas 23 to 27: 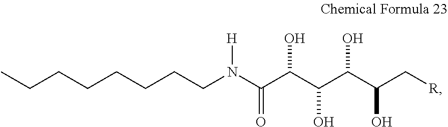
wherein, in Chemical Formula 23, R represents at least one selected from —OH, 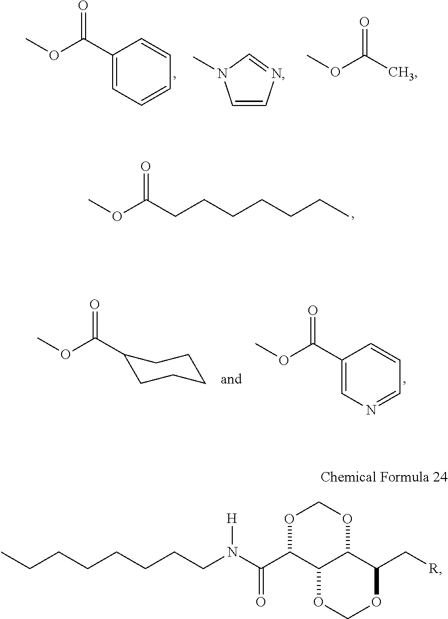
wherein in Chemical Formula 24, R represents at least one selected from —OH, 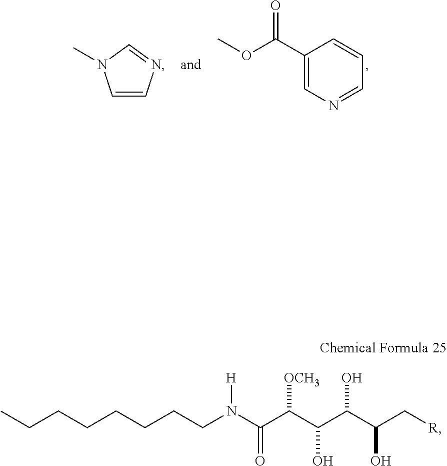
wherein in Chemical Formula 25, R represents at least one selected from —OH,

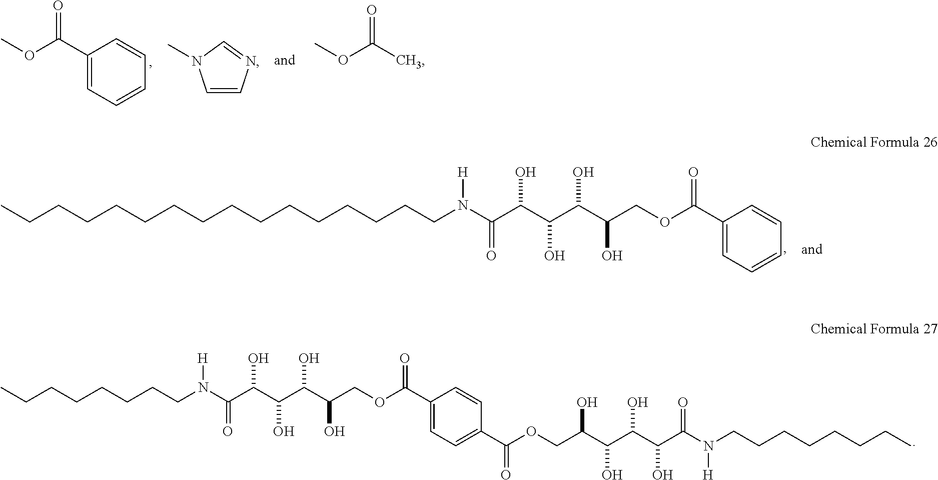

16. A liquid crystal display device comprising:
an array substrate comprising a switching element and a pixel electrode electrically connected to the switching element;
an opposing substrate facing the array substrate; and
a liquid crystal layer comprising a liquid crystal composition comprising
about 70 percent by weight to about 98 percent by weight of a liquid crystal molecule, and
about 2 percent by weight to about 30 percent by weight of a hydrogel agent, each based on a total weight of the liquid crystal composition.

17. The liquid crystal display device of claim 16, wherein the array substrate further comprises a common electrode, which is effective to form an electric field with a pixel electrode when provided with a voltage.

18. The liquid crystal display device of claim 17, wherein the liquid crystal composition has an optically isotropic phase when an electric field is not present between the pixel electrode and the common electrode.

19. The liquid crystal display device of claim 16, wherein the hydrogel agent comprises an alkylamide compound.

20. The liquid crystal display device of claim 16, wherein the liquid crystal composition further comprises less than about 20 percent by weight of a chiral dopant.
